(19) United States
(12) Patent Application Publication
(10) Pub. No.: US 2009/0266640 A1
(43) Pub. Date: Oct. 29, 2009

(54) ELECTRIC POWER STEERING APPARATUS

(75) Inventors: Atsushi Oshima, Fujisawa-shi (JP); Shigeru Endou, Fujisawa-shi (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 12/093,234

(22) PCT Filed: Nov. 9, 2006
(86) PCT No.: PCT/JP2006/322402

§ 371 Date: May 9, 2008

(30) Foreign Application Priority Data
Nov. 10, 2005 (JP) 2005-325958
Oct. 10, 2006 (JP) 2006-276171

(51) Int. Cl. B62D 5/04; F16H 55/18

(52) U.S. Cl. 180/444; 74/409

(57) ABSTRACT

Since a housing 101 is integrally formed with a frame main body 123A of a frame 223 so as to surround a rotor yoke 258 and a stator yoke 242, heat generated from a motor 109 is conducted to the housing 101 to be thereby emitted to the outside. Accordingly, a heat transfer property and a cooling effect of the motor 109 are remarkably improved compared with a case that the housing 101 is formed into a member separated from a frame 123. As a result, it is possible to realize an increase in output of the motor 109 as well as a decrease in size and weight, thereby realizing a decrease in size of an electric power steering apparatus as a whole.

### TECHNICAL FIELD

The present invention relates to an electric power steering apparatus, and more particularly, to an electric power steering apparatus capable of realizing a decrease in size and weight.

### BACKGROUND ART

An electric power steering apparatus detects steering torque generated from a steering shaft upon operating a steering wheel and other signals to drive an electric motor on the basis of the detected signals and to rotate an output shaft through a decelerator, thereby assisting a steering force.

In recent electric power steering apparatuses, it has been demanded that a high-output motor is controlled at high accuracy in order to obtain a good feeling while outputting an assisting force which is several times larger than human's steering force. Additionally, a decrease in size and weight of the motor has been demanded in order to realize a decrease in weight of a vehicle body and to ensure safety in a collision. For this reason, as the motor used in the electric power steering apparatus, a brushless motor which can realize a decrease in size and weight while being excellently controlled is suitably used instead of a brush DC motor.

Additionally, in the electric power steering apparatus disclosed in Patent Document 1, a power transmission is carried out in such a manner that a worm which is connected to a rotation shaft of the electric motor meshes with a worm wheel which is connected to an output shaft.

Patent Document 1: JP-A-2005-312087

Patent Document 2: JP-A-9-30432

Patent Document 3: JP-A-2005-219708

### DISCLOSURE OF THE INVENTION

### Problems to be Solved by the Invention

However, since the brushless motor used for the recent electric power steering apparatus is optimally designed, a motor constant (torque per unit copper loss, Nm/√w) reaches the approximate upper limit and the motor constant tends to be the same in motors with the same volume. In contrast, a decrease in size and weight has been demanded in recent years more than before. At the same time, an increase in output has been demanded. As a method for realizing a decrease in size and weight without reducing an output in order to satisfy the contrast demands, it may be supposed that heat generated from the coil is emitted to the outside.

However, in a case that a motor frame as a motor assembly is isolated in the motor having substantially the same volume, a heat transfer to a worm gear housing or an ambient atmosphere limitedly occurs, and thus it is very difficult to realize a decrease in size while improving a heat transfer property. Additionally, when the motor frame is made of resin in the same manner as Patent Document 1, a problem arises in that a heat transfer property further decreases.

The present invention is contrived in consideration of the above-described problems, and an object of the invention is to provide an electric power steering apparatus capable of realizing a decrease in size and weight without reducing an output.

Here, Patent Document 2 discloses a bearing pre-loading device in which the rotation shaft of the electric motor is rotatably supported by two ball bearings, and the outer race of the ball bearing on the worm side is pressed toward the outer race on the other side to apply a pre load to the two bearings, thereby removing rattling movement. However, according to the bearing pre-loading device, an assembling becomes complicated because it is necessary to manage the pre load. Additionally, operation torque of the bearing becomes large due to the pre load, and a problem may arise in that a so-called handle return becomes poor.

Meanwhile, a worm pre-loading device may be provided in the vicinity of the ball bearing on the side of the worm in order to remove a backlash occurring when the worm and the worm wheel mesh with each other (see Patent Document 3). When such a worm pre-loading device is provided, it is difficult to provide the bearing pre-loading device. Additionally, a problem arises in that heat increases when an increase in output of the motor is realized or a decrease in size cannot be realized when a heat emission is sufficiently carried out.

The present invention is contrived in consideration of the above-described problems, and an object of the invention is to provide a compact electric power steering apparatus capable of supporting the rotation shaft of the electric motor without rattling movement (a backlash generated from the inside of the bearing and a portion where the worm and the worm wheel mesh with each other).

### Means for solving the Problems

There is provided an electric power steering apparatus including:

a housing;

a motor which is attached to the housing to rotate a rotation shaft;

an output shaft which outputs a steering force for steering a vehicle wheel;

an input shaft which transmits the steering force from the steering wheel to the output shaft; and

a power transmission mechanism which connects the rotation shaft of the motor and the output shaft so that a power is transmitted, wherein

the power transmission mechanism includes a worm which is integrally formed with the rotation shaft and a worm wheel which is connected to the output shaft.

There is provided an electric power steering apparatus including:

a housing;

a motor which is attached to the housing to rotate a rotation shaft;

an output shaft which outputs a steering force for steering a vehicle wheel;

an input shaft which transmits the steering force from the steering wheel to the output shaft; and

a power transmission mechanism which connects the rotation shaft of the motor and the output shaft so that a power is transmitted, wherein

the power transmission mechanism includes a worm which is integrally formed with the rotation shaft and a worm wheel which is connected to the output shaft, and

an integrally formed housing of the power transmission mechanism forms at least a part of a frame of the motor.

### EFFECTS OF THE INVENTION

In the past, since the worm is formed into a member separated from the motor shaft, it is necessary to support each shaft at two points (four points in total), thereby occupying a space. Additionally, a shaft connecting operation needs to be carried out by a coupling or a serration joint, which results in a structure that rattling movement easily occurs in a rotation direction. On the contrary, according to the electric power steering apparatus related to the invention, since the power transmission mechanism includes the worm which is integrally formed with the rotation shaft and the worm wheel which is connected to the output shaft, it is possible to support the rotation shaft without rattling movement in the rotation direction, thereby providing the simple and compact electric power steering apparatus.

According to the electric power steering apparatus related to the invention, since the power transmission mechanism includes the worm which is integrally formed with the rotation shaft and the worm wheel which is connected to the output shaft, it is possible to support the rotation shaft without rattling movement, thereby providing the simple and compact electric power steering apparatus.

Additionally, when the housing of the power transmission mechanism is formed into a member separated from the frame of the motor in the same manner as the known example, although they are appeared to be connected to each other, a contact area in a micro unit is very small, and thus a problem arises in that heat transmitted from the frame to the housing is small. On the contrary, when the integrally formed housing of the power transmission mechanism forms at least a part of the frame of the motor in the same manner as the invention, heat generated from the motor is conducted though the housing to be thereby emitted to the outside. Accordingly, a heat transfer property is remarkably improved and a cooling effect of the motor increases compared with a case that the housing is formed into a member separated from the frame. As a result, it is possible to realize an increase in output of the motor as well as a decrease in size and weight. Furthermore, it is possible to realize a decrease in size of the electric power steering apparatus as a whole.

Additionally, since the motor needs to be assembled in a case that the housing of the power transmission mechanism is formed into a member separated from the frame of the motor, it is necessary to provide a partition plate or an attachment flange which requires a space to the frame. On the contrary, when the housing is integrally formed with the frame in the same manner as the invention, it is not necessary to provide such a partition plate, and thus it is possible to realize a decrease in size of the motor as much as a space of the partition plate. Additionally, when the partition plate is not provided, a distance between the winding wire of the coil of the motor as a heat source and the housing of the power transmission mechanism having large heat capacity and surface area becomes short, and thus it is possible to expect a large heat transfer property. Further, since it is not necessary to provide the flange used for a case that the housing of the power transmission mechanism is formed into a member separated from the frame, it is possible to realize a decrease in size and weight of the electric power steering apparatus.

It is desirable that the housing of the power transmission mechanism surrounds the rotor and the stator of the motor because heat generated from the winding wire of the coil can be more efficiently conducted to the housing.

It is desirable that the motor is a brushless motor.

It is desirable that the housing of the power transmission mechanism is made of aluminum, aluminum alloy, magnesium, or magnesium alloy which has thermal conductivity larger than that of iron because a heat transfer property can be increased and a decrease in size and weight of the motor can be realized.

When the housing of the power transmission mechanism is provided with a rib which is disposed in the vicinity of a connection portion of the brushless motor, it is possible to increase a surface area of the housing and to improve strength of the housing, thereby promoting a heat emission form the brushless motor.

Since the rotation shaft is supported to the housing through the four-point contact ball bearing, it is possible to support the rotation shaft and the worm which is integrally formed with the rotation shaft while restricting rattling movement.

It is desirable that a worm pre-loading mechanism is provided so as to apply a pre load to tooth surfaces of the worm and the worm wheel meshing with the worm.

It is desirable that the rotation shaft is supported to the housing through a bearing at two positions as opposite ends thereof and the bearing on the side of the motor is a four-point contact ball bearing.

It is desirable that the housing is integrally formed with the frame of the motor. ‘To be integrally formed’ includes both to be partially integrally formed and to be completely integrally formed.

It is desirable that the material of the housing is aluminum, aluminum alloy, magnesium, or magnesium alloy.

### BRIEF DESCRIPTION OF THE DRAWINGS

FIG. 1 is a schematic view illustrating a steering mechanism with an electric power steering apparatus 100 according to an embodiment.

FIG. 2 is a sectional view illustrating the electric power steering apparatus 100 according to the embodiment when taken along the arrow II shown in FIG. 1.

FIG. 3 is a view illustrating the configuration shown in FIG. 1 when taken along the line III-III.

FIG. 4(a) is a view illustrating the configuration shown in FIG. 3 when taken along the line IV-IV shown in FIG. 3, and FIG. 4(b) is an enlarged view illustrating the part indicated by the arrow IVB shown in FIG. 4(a).

FIG. 5 is an enlarged view illustrating the part indicated by the arrow V shown in FIG. 3.

FIG. 6 is a view illustrating the configuration shown in FIG. 5 when taken along the line VI-VI.

FIG. 7 is a perspective view illustrating the worm pre-loading mechanism 120.

FIG. 8 is an exploded view illustrating the worm pre-loading mechanism 120.

FIG. 9 is a perspective view illustrating a housing according to a modified example.

FIG. 10 is a schematic view illustrating a steering mechanism with a pinion-type electric power steering apparatus 100 according to another embodiment.

### DESCRIPTION OF REFERENCE NUMERALS AND SIGNS

1: STEERING WHEEL
7A: UNIVERSAL JOINT
7B: UNIVERSAL JOINT
8: INTERMEDIATE SHAFT
9: RACK SHAFT
10: PINION SHAFT
13: TIE-ROD
15: COLUMN
15: STEERING COLUMN
17: STEERING SHAFT
18: BRACKET
24: BRACKET
26: VEHICLE BODY
100: ELECTRIC POWER STEERING APPARATUS
101: HOUSING
101a: COVER MEMBER
101b: MAIN BODY
101c: LARGE HOLE
102: INPUT SHAFT
103: OUTPUT SHAFT
104, 110: BEARING
105: TORSION BAR
106: TORQUE SENSOR
107: WORM WHEEL
107a: STEEL CORE
107b: TOOTH PORTION
108: WORM
108: WORM WHEEL
109: MOTOR
109A: FRONT END PORTION
109F: FRAME
109a: ROTATION SHAFT
109b: ROTOR
109d: STATOR
109e: SEAL
111: FOUR-POINT CONTACT BEARING HOLDING
112: FOUR-POINT CONTACT BALL BEARING
113: BALL BEARING
120: WORM PRE-LOADING MECHANISM
121: BUSH
121a: OUTSIDE FLANGE
121b: INSIDE FLANGE
122: HOLDER
122c: CLAW PORTION
123: PRE-LOADING PAD
123a: PLANE PORTION
123b: TAPER-SHAPED INNER CIRCUMFERENTIAL SURFACE
123c: STEP PORTION
123e: PROTRUSION
123f: LOWER OUTER CIRCUMFERENTIAL SURFACE
124: COIL
124a: ONE END
124b: THE OTHER END
221: STATOR
222: RESOLVER
222s: RESOLVER STATOR
222r: RESOLVER ROTOR
222n: NUT
223: MOTOR HOUSING
223A: MOTOR HOUSING BODY
223B: MOTOR HOUSING COVER PORTION
223a: INNER DIAMETER PORTION
223b: INNER DIAMETER PORTION
223c: SMALL DIAMETER PORTION
230: CONCAVE PORTION
241: SPLIT CORE
242: STATOR YOKE
243: YOKE
243: MAGNETIC POLE PORTION
243a: HAT PORTION
244: MOTOR COIL
245: CONVEX HALF PORTION
246: CONVEX PORTION
247: STATOR YOKE CONTACTING PORTION
248: STATOR FRONT END CONTACTING PORTION
249: HEAT TRANSFER MEMBER
250: BUS BAR
257: MAGNETIC POLE PORTION
258: ROTOR YOKE
259: PERMANENT MAGNET
260: CAP

### BEST MODE FOR CARRYING OUT THE INVENTION

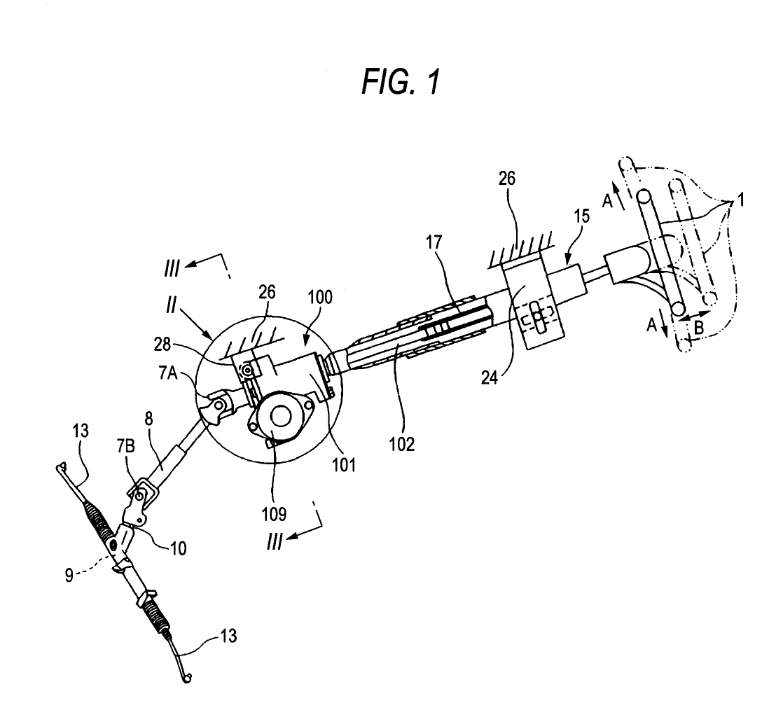

Hereinafter, an exemplary embodiment of the invention will be described with reference to the accompanying drawings. FIG. 1 is a schematic view illustrating a steering mechanism with a column-type electric power steering apparatus 100 according to an embodiment. In FIG. 1, a tube-shaped column 15 is supported to a vehicle body 26 through a bracket 24 so as to be movable in a tilt direction (in the direction indicated by the arrow A) and a telescopic direction (in the direction indicated by the arrow B). A steering shaft 17 having a steering wheel 1 attached to the front end is inserted through the steering column 15 so as to be rotatable therein. The steering column 15 and the steering shaft 17 are configured as a collapsible structure to be deformed in a collapsible manner upon being applied with a large shock in an axial direction in a second collision.

The lower end of the steering shaft 17 is connected to an input shaft 102 of the electric power steering apparatus 100 which is attached to the vehicle body 26 through a bracket 18. Meanwhile, an output shaft 103 of the electric power steering apparatus 100 is connected to the upper end of an intermediate shaft 8 through a universal joint 7A and the lower end of the intermediate shaft 8 is connected to a pinion shaft 10 through a universal joint 7B. A pinion formed in the pinion shaft 10 meshes with a tooth of a rack formed in a rack shaft 9. Opposite ends of the rack shaft 9 are respectively connected to steering mechanisms (not shown) for steering vehicle wheels through tie-rods 13.

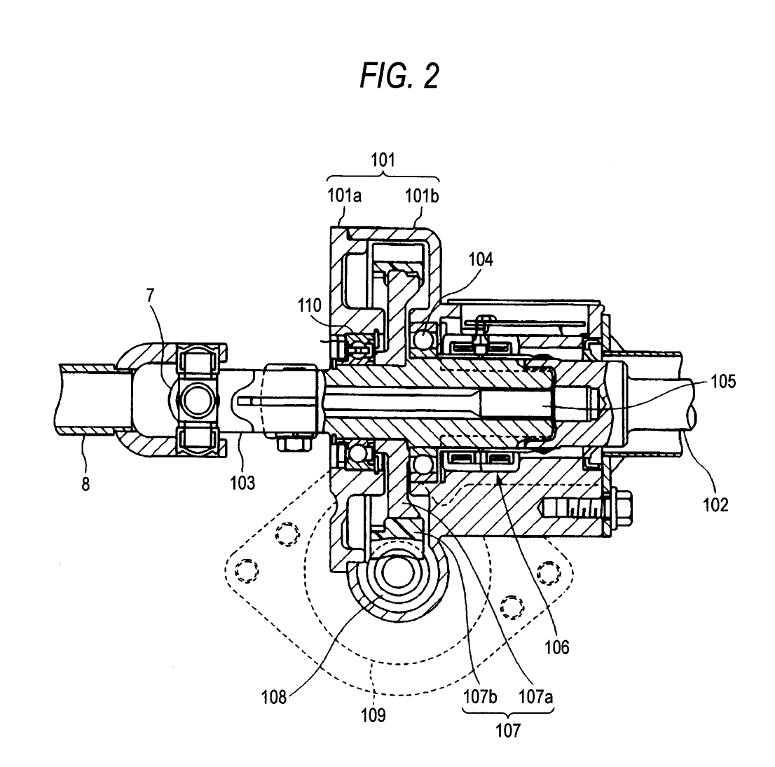

FIG. 2 is a sectional view illustrating the electric power steering apparatus 100 according to the embodiment when taken along the arrow II shown in FIG. 1. The input shaft 102 and the output shaft 103 are disposed inside a housing 101 which includes a main body 101b and a cover member 101a made of aluminum, aluminum alloy, magnesium, or magnesium alloy. The input shaft 102 is rotatably supported to the housing 101 through a bearing (not shown). The hollow output shaft 103 is rotatably supported to the housing 101 through bearings 104 and 110. In FIG. 2, a torsion bar 105 of which the right end is press-inserted into the input shaft 102 and the left end is pin-connected to the output shaft 103 extends in the output shaft 103.

In FIG. 2, a detection device, that is, a torque sensor 106 is provided at a position opposed to the outer circumference around the right end of the output shaft 103 so as to detect steering torque on the basis of torsion amount of the torsion bar 105 caused by applied torque. The torque sensor 106 is a rotation non-contact torque sensor which detects a variation in impedance of a predetermined magnetic circuit as a relative variation between angles of the input shaft 102 and the output shaft caused by the torsion of the torsion bar 105 by the use of a coil and which outputs the detected value in the form of electric signal to a control circuit (not shown).

A worm wheel 107 is disposed between the bearings 104 and 110 in the middle of the output shaft 103. The worm wheel 107 includes a steel core 107a which is attached to the output shaft 103 by a press-inserting operation to rotate together and a resin tooth portion 107b which is formed in the outer circumference thereof by an insert-forming operation. The tooth portion 107b of the worm wheel 107 meshes with a worm 108 which is integrally formed with the rotation shaft of a motor 109 attached to the housing 101. The worm wheel 107 and the worm 108 constitute a power transmission mechanism (worm mechanism). Accordingly, the housing 101 corresponds to a housing for receiving the power transmission mechanism therein.

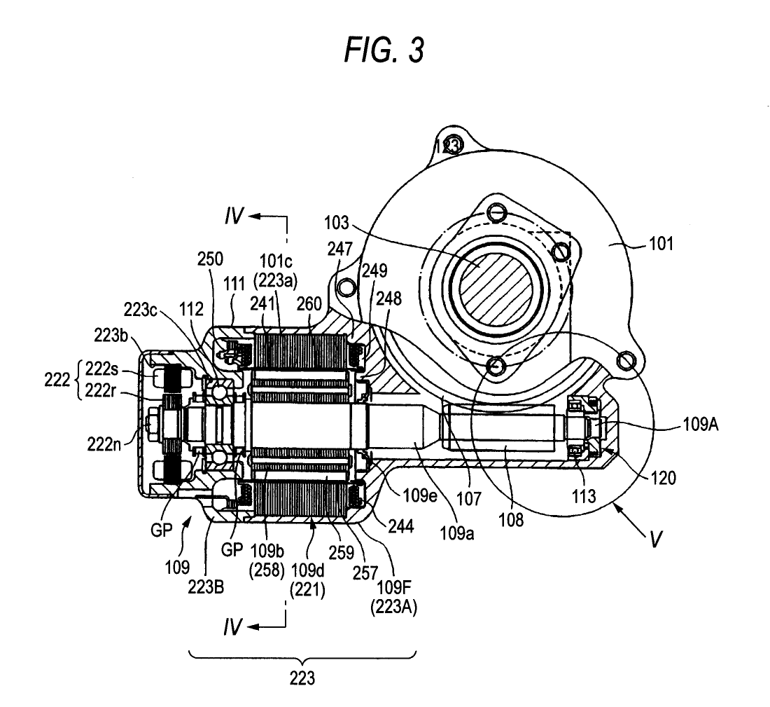

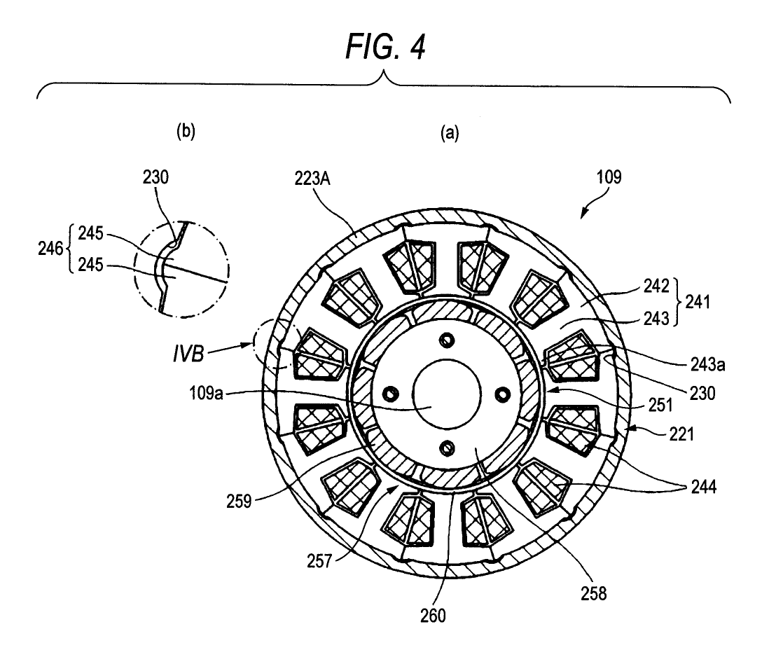

FIG. 3 is a view illustrating the configuration shown in FIG. 1 when taken along the line III-III. FIG. 4(a) is a view illustrating the configuration shown in FIG. 3 when taken along the line IV-IV shown in FIG. 3, and FIG. 4(b) is an enlarged view illustrating the part indicated by the arrow IVB shown in FIG. 4(a). In FIG. 3, the brushless motor 109 is disposed inside an inner-diameter portion 223a of a frame main body 223A which is integrally formed with the housing 101. As shown in FIG. 3, the brushless motor 109 includes a motor housing (which is called a frame) 223 which receives a stator 221 and a resolver 222 corresponding to a rotation angle detector for detecting a rotation angle of the rotor therein. The motor housing 223 is integrally formed with the housing 101 which receives the worm mechanism therein and is separated into two members, that is, the motor housing main body 223A which receives the stator 221 therein and a motor housing cover portion 223B which receives the resolver 222 therein, both of them being fixed to each other by a socket and spigot joint.

Concave portions 230 (see FIG. 4) with a circular arc shape in a sectional view are formed at the same intervals in the inner circumferential surface of the inner-diameter portion 223a of the motor housing main body 223A so as to extend from an end surface on the side of the motor housing cover portion 223B by substantially the same length in an axial direction as that of the stator 221 and to have the same number as that of the slots of the brushless motor.

In addition, as clearly shown in FIG. 3, an inner-diameter portion 223b which receives the resolver 222 therein is formed in the inner circumferential surface of the end of the motor housing cover portion 223B on the side opposite to the motor housing main body 223A, and a small-diameter portion 223c which communicates with the inner-diameter portion 223b is fitted to a four-point contact ball bearing 112. A plurality of fin-shaped ribs (not shown) are integrally formed with a position of the outer circumferential surface opposed to the resolver 222 (a position around the connection portion of the motor) at the same intervals in the circumferential direction so as to protrude in a radial direction. Additionally, the motor housing cover portion 223B is integrally formed by casting any one of aluminum, aluminum alloy, magnesium, and magnesium alloy using a die casting machine in the same manner as the motor housing main body 223A and the housing 101. Then, a socket-and-spigot-joint portion and the like may be formed by mechanical working.

As shown in FIG. 4(a), the stator 221 is fitted to the inside of the inner-diameter portion 223a of the motor housing main body 223A. The stator 221 is configured such that T-shaped split cores 241 having twelve laminated electromagnetic steel plates are connected to each other in a circular-ring shape.

In the cross section perpendicular to the axial direction, each split core 241 is configured as a T-shaped iron core including a stator yoke 242 of which the outer circumferential surface is formed into a circular arc shape and which extends in the circumferential direction and a magnetic pole portion 243 which extends from the center portion of the inner circumferential surface of the stator yoke 242 in the circumferential direction to the inner center axis, and a hat portion is formed in the front end of the magnetic pole portion 243. Then, a motor coil 244 is concentratedly wound around the magnetic pole 243. The hat portion has a shape in which a slight slot opening width is formed in a state that the twelve T-shaped split cores 241 are combined in a circular-ring shape, and the slot opening width is set to be not more than a diameter of a magnet wire used for the motor coil 244. Although a surface of the stator yoke 242 fitted to the motor housing main body 223A has approximately the same curvature as that of the motor housing, since a part just in rear of the head part of the magnetic pole portion 243 is flat, the surface of the stator yoke comes into line contact with the motor housing main body at two points upon being fitted to the motor housing main body 223A.

Meanwhile, the stator yoke 242 on the slot side is formed into a linear shape perpendicular to the central line of the head part of the magnetic pole portion 243. A part that the adjacent split cores 241 comes into contact with each other has a linear shape which is inclined at ±15° with respect to the central line of the magnetic pole portion 243 to which the motor coil 244 is applied so as to intersect with the rotation center of the magnetic pole portion and also has a shape in which the split cores come into surface contact with each other.

Additionally, opposite ends of the outer circumferential surface of the base portion 242 on the side of the outer circumference in the circumferential direction engaging with the concave portion 230 of the motor housing main body 223A are formed into convex half portions 245 with a quarter-circle shape which are formed in the whole area in the circumferential direction. Accordingly, as shown in FIG. 4(b), when the split cores 241 are connected to each other, both convex half portions 245 are formed into a convex portion 246 which engages with the concave portion 230 formed in the motor housing main body 223A so as to have a semi-circular shape in a sectional view and which has the same curvature as that of the concave portion 230. At this time, the center point of the convex portion is slightly deviated to the central axis of the stator more than the center point of the concave portion 30 of the motor housing main body 223A. Then, the circular-ring shaped stator 221 is configured by performing a welding operation such as a laser welding to the convex portion 246 in a state that the respective split cores 241 are connected to each other in a circular-ring shape, and the stator 221 is fitted to the inner-diameter portion 223a of the motor housing main body 223A by allowing the convex portion 246 to engage with the concave portion 230. At this time, a stator yoke contacting portion 247 which allows the yoke 243 of the stator 221 formed in the motor housing main body 223A to be contacted and a stator front end contacting portion 248 which allows the front end of the stator 221 to be contacted are formed into a shape in which both portions come into contact with the end surface of the stator 221. Additionally, a heat transfer member 249 formed of epoxy-based resin is filled in a gap between the coil end and the both portions.

Phase terminals of the motor coil 244 are connected to a circular-ring shaped bus bar 250 which is formed into a fourth floor structure in which the midpoint of Y wire connection, U phase, V phase, and W phase are insulated (see FIG. 3), and the bus bar 250 is fitted to the motor housing main body 223A by shrink-fitting.

In this way, since the stator 221 is of a split core type, it is not necessary to provide a slot space for the configuration of the winding wire in a single core type, such as a space for passing a winding wire nozzle used when winding a winding wire or a space for guiding the winding wire dropped into the slot, thereby winding the winding wire with high density.

Additionally, in the split core 241, since the slot opening width formed by the hat portion 243a is set to be not more than the diameter of the magnet wire used for the motor coil 244, even when the motor coil 244 is loosened or disconnected, the motor coil is not drawn into the air gap, and thus it is possible to prevent a steering wheel lock due to the motor lock.

Further, in the split core 241, since the surface of the stator yoke 242 on the side of the motor housing main body 223A comes into line contact with the motor housing main body at two points upon being fitted to the motor housing main body, even when a reaction force is applied to a magnetic pole portion 257 due to the generated torque, the T-shaped split core 241 hardly falls down, thereby reducing noise and vibration.

Furthermore, in the T-shaped split core 241, since the stator yoke 242 on the slot side is formed into the linear shape perpendicular to the central line of the head part of the magnetic pole portion 257, the stator yoke 242 does not interrupt when winding the winding wire, thereby winding the winding wire with high density.

Then, in the T-shaped split core 241, since the convex half portions 245 are formed in the outer circumferences of the part in which the stator yokes 242 of the adjacent split cores 241 come into contact with each other, a contacting area is larger than that of a split core in which a stator yoke with a simple circular-ring shape is split. Accordingly, even when a reaction force is applied to each of the magnetic pole portions 257 due to the generated torque, the T-shaped split core 241 hardly falls down. Additionally, the convex half portions 245 which protrude to the outer circumference are welded, magnetic flux passing the welding portion is small and thus a hysteresis loss is small. In terms of such advantages, it is possible to reduce noise, vibration, and iron loss.

Since the convex portion 246 protrudes to the outer circumference, it is possible to prevent a magnetic path from thinning due to the fact that the stator yoke 242 on the slot side is formed into the linear shape intersecting with the central line of the head part of the magnetic pole portion 257.

Since the convex portion 246 has a large gap in a diameter direction with respect to the concave portion formed in the motor housing main body 223A, but does not have a gap in the rotation direction, the convex portion can be inserted by heating into the housing main body 223A without a bead or a swell generated when welding the split cores 241 to each other. Then, since the stator 221 does not rotate idly even when a fitting allowance between the motor housing main body 223A and the stator 221 does not exist due to the fact that only the motor housing main body 223A becomes a high temperature due to the abruptly increasing ambient temperature of the brushless motor 109 or a fact that a crack occurs in the motor housing main body 223A due to an unexpected external force, it is possible to surely prevent symptoms such as a torque reduction, a torque ripple, a torque difference caused by a rotation direction, and a self steer.

In addition, as described above, since the concave portion 230 of the motor housing main body 223A extends in a uniform shape from a side to be attached with the motor housing cover portion 223B to a position slightly deeper than the stator yoke contacting portion through a stator fitting portion, it is not necessary to change the shape of the electromagnetic steel plate in an appropriate direction, and it is possible to configure the stator 221 using the T-shaped electromagnetic steel plate with the same shape.

The characteristic is that the same advantage can be obtained from an expanding core-type stator in which the T-shaped split cores 241 are connected to each other as many as the number of the slots and the connection portion is bent to thereby configure the circular-ring shaped stator 221. In addition, a resolver stator 222s which constitutes the resolver 222 is fitted to the inside of the inner-diameter portion 223b of the motor housing cover portion 223B.

Meanwhile, a resolver rotor 222r, which is opposed to the resolver stator 222s attached to the inner-diameter portion 223b of the motor housing cover portion 223B, is fixed to the end of a rotation shaft (rotor) 109a of the motor 109 by a nut 222n so as to rotate together. The resolver stator 222s and the resolver rotor 222r constitute the resolver 222.

Here, the magnetic pole portion 257 includes a cylindrical rotor yoke 258 through which the rotation shaft 109a is inserted, eight sheets of permanent magnets 259 which are attached to the outer circumferential surface of the rotor yoke 258 at the same intervals in the circumferential direction, and a cap 260 which is made of austenite-based nonmagnetic stainless to cover the outer circumferential surface of the permanent magnets 259. The permanent magnet 259 as a magnetic pole corresponds to a segment magnet which is separated for each pole, and the shape is a semi-cylindrical shape in which the circular arc center on the outer circumference is intentionally deviated from the rotation center.

The outer circumferential portion of the permanent magnet 259 constituting the magnetic pole portion 257 is covered by the cap 260. At this time, the cap 260 is loosely fitted to the permanent magnet 259, but fixed thereto using an additional adhesive, and then the end surface of the cap 260 is caulked by a rivet, thereby more strongly fixed thereto.

A gap between the rotation shaft 109a and the inner-diameter portion 223a of the motor housing main body 223A is sealed by a seal 109e. One end (left end shown in FIG. 3) of the rotation shaft 109a of the motor 109 is supported to the motor housing cover portion 223B through the four-point contact ball bearing 112.

A rubber damper GP which is attached to the outer circumference of the rotation shaft 109 is disposed on both sides of the four-point contact ball bearing 112 in the axial direction so as to allow the four-point contact ball bearing 112 to be displaced in the axial direction with respect to the rotation shaft 109 and to apply an urging force in accordance with the displacement amount. On the other hand, the other end (the right end shown in FIG. 3) of the rotation shaft 109a is supported to the housing 101 by a general ball bearing 113 through a worm pre-loading mechanism 120.

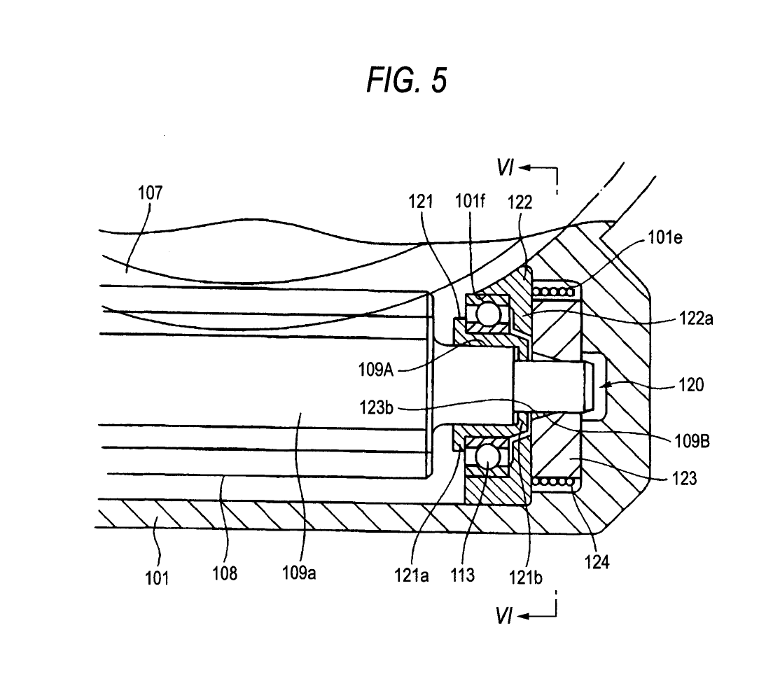

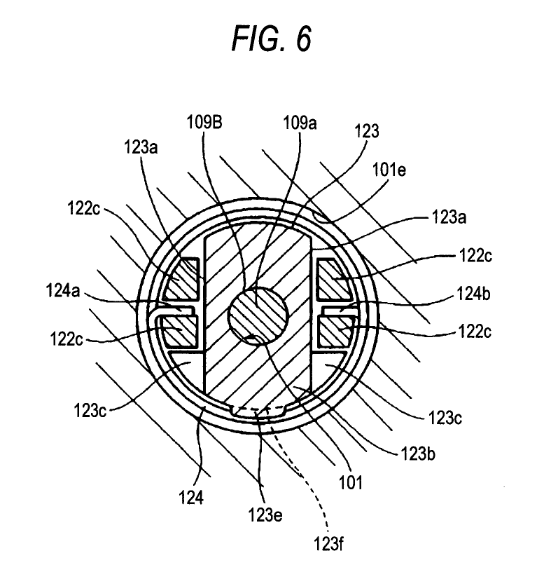

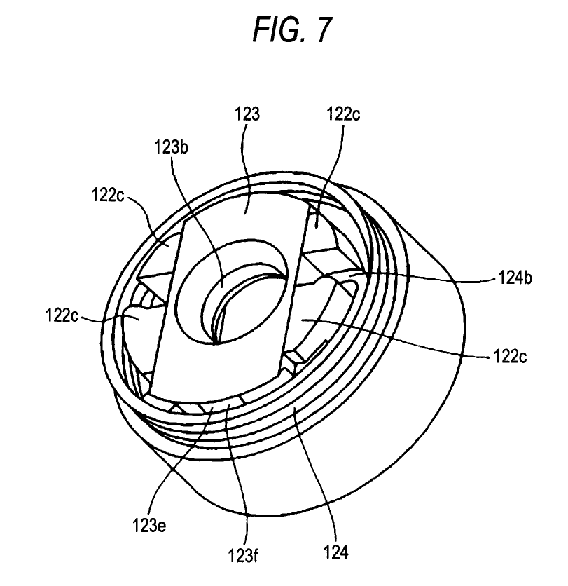

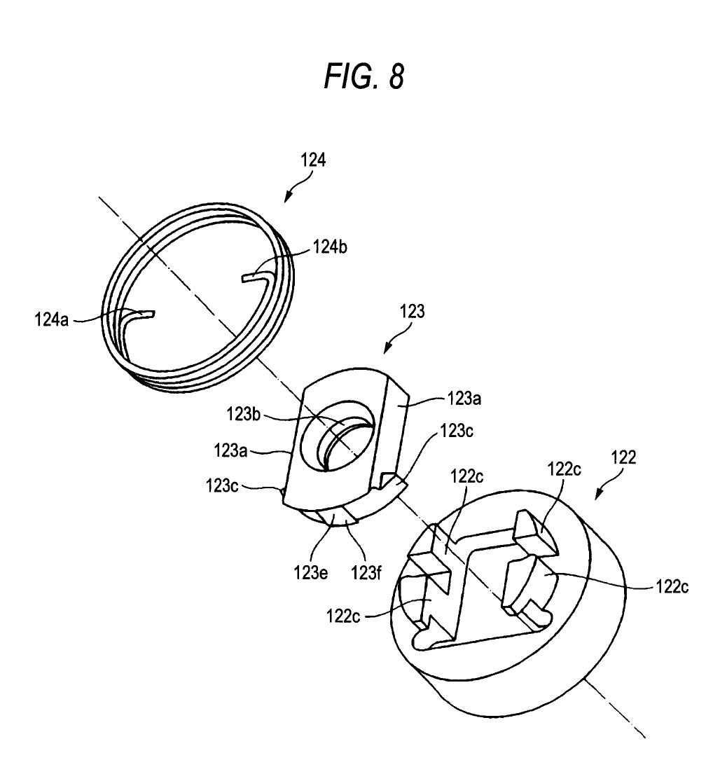

FIG. 5 is an enlarged view illustrating the part indicated by the arrow V shown in FIG. 3, and FIG. 6 is a view illustrating the configuration shown in FIG. 5 when taken along the line VI-VI. FIG. 7 is a perspective view illustrating the worm pre-loading mechanism 120, and FIG. 8 is an exploded view illustrating the worm pre-loading mechanism 120. In FIG. 5, a bush 121 made of an elastic member is interposed between the inner race of the ball bearing 113 and the end of the rotation shaft 109a.

Meanwhile, a holder 122 with an L-shape in a sectional view is interposed between the ball bearing 113 and a bag hole 101f of the housing 101. A first front end 109A and a second front end 109B having a diameter smaller than that of the first front end are provided in the end of the rotation shaft 109a, and the second front end 109B protrudes from the holder 122. At this time, a pre-load pad 123 is disposed around the second front end. The positioning operation of the ball bearing 113 in the axial direction is carried out by an outer flange 121a of the bush 121 which comes into contact with the inner race and a flange portion 122a of the holder 122 which is opposed to the bush so as to come into contact with the outer race. An inner flange 121b of the bush 121 comes into contact with the outer circumferential surface of the second front end 109B.

The pre-load pad 123 is made by injecting synthetic resin mixed with solid lubricants, and has a taper-shaped inner circumferential surface 123b formed in the inner circumference so as to be enlarged inwardly. The second front end 109B of the rotation shaft 109a is fitted to the taper-shaped inner circumferential surface 123b. The pre-load pad 123 is formed into an inverse T-shape when viewed from the direction shown in FIG. 6. That is, the pre-load pad includes plane portions 123a which are provided in parallel with an axis interposed therebetween and end portions 123c which connect to the lower ends thereof in the outer circumference.

In the outer circumferential surface of the pre-load pad 123, a protrusion 123e is provided in the lower side shown in FIG. 6 so as to protrude from the cylindrical surface. The pre-load pad 123 is combined in the holder which is fitted to the inside of the housing 101. That is, the holder 122 includes four claw portions 122c which protrude in the axial direction, and the left claw portions 122c shown in FIG. 6 are disposed adjacent to the left plane portion 123a of the pre-load pad 123. On the other hand, the right claw portions 122c are disposed adjacent to the right plane portion 123a of the pre-load pad 123. Each of the claw portions 122c has an outer surface which is substantially in concord with the cylindrical surface of the pre-load pad 123 while being combined in the pre-load pad 123.

A torsion coil 124 is wound several times around the outer circumference of the pre-load pad 123 in a state that one bent end 124a is inserted between the left claw portions 122c and the other bent end 124b is inserted between the right claw portions 122c.

In terms of the combination of the holder 122 and the pre-load pad 123, they are restricted from relatively moving in the axial direction. Then, when opposite ends 124a and 124b of the torsion coil 124 are disposed between the adjacent claw portions 122c which are provided in a part of the holder 122 and then the torsion coil spring 124 is fitted to the outside of the outer circumferential surface of the pre-load pad 123 and the outer-diameter side surfaces of the claw portions 122c, the central axis of the taper-shaped inner circumferential surface 123b provided in the pre-load pad 123 is deviated to one side (the upper side shown in the drawing) with respect to the central axis of the holder 122 in a state that a lower outer circumferential surface 123f provided in the pre-load pad 123 does not come into contact with the inner circumferential edge of the torsion coil 124. For this reason, when the holder 122 is fixed to a predetermined portion of the housing 101 in a state that the pre-load pad 123 and the torsion coil 124 are combined in the holder 122 and then the second front end 109B of the worm shaft 109a is inserted into the inner side of the taper-shaped inner circumferential surface 123b provided in the pre-load pad 123, the diameter of the torsion coil 124 can be elastically widened by the lower outer circumferential surface 123f provided in the pre-load pad 123. Then, since the torsion coil 124 tends to be elastically restored in a direction in which the torsion coil is rewound (the diameter decreases), the torsion coil 124 applies an elastic force to the pre-load pad 123 toward the worm wheel 107. Accordingly, a distance between the output shaft 103 of which the outside is fitted to the worm wheel 107 and the rotation shaft 109a decreases. As a result, the tooth surfaces of the worm 108 and the worm wheel 107 come into contact with each other while being applied with a pre-load.

In this way, in the electric power steering apparatus mounted with the worm wheel mechanism according to the embodiment, since a backlash between the tooth surfaces of the worm 108 and the worm wheel 107 is adjusted by applying a pre load using the worm pre-loading mechanism 120, it is possible to prevent rattling sound of the engagement portion from occurring due to a shock or vibration applied from a vehicle wheel and the like.

Next, an operation of this embodiment will be described. When a steering force is not applied from the steering wheel 1 to the input shaft 102 through the steering shaft 17 in a state that the vehicle moves forward, the torque sensor 106 does not generate an output signal, and thus the motor 109 does not generate an auxiliary steering force.

On the other hand, when a driver operates the steering wheel 1 in a state that the vehicle turns its direction, the torsion bar 105 twisted in accordance with the force, and then a relative rotating motion occurs between the input shaft 102 and the output shaft 103. The torque sensor 106 outputs a torque signal in accordance with the direction and amount of the relative rotating motion. Since a control circuit (not shown) supplies three phases of current to the motor 109 in accordance with the rotor rotation angle detected by the resolver 222 based on a predetermined control map obtained from the torque signal and a vehicle speed signal from a sensor (not shown), the motor 109 generates a desired auxiliary steering force. The torque generated by the motor 109 is decelerated by the power transmission mechanisms (108 and 107) and then is transmitted to the output shaft 103. Subsequently, the torque assists the movement of the rack shaft 9 through the intermediate shaft 8. Accordingly, the steering mechanism is operated through the tie-rod 13 to thereby steer a vehicle wheel (not shown).

At this time, although a rotation magnetic field is generated by supplying relatively high current to the motor coil 244 of the stator 221 of the brushless motor 109 to thereby drive the rotation shaft 109a to rotate, since the motor driving current is high current, heat occurs in the motor coil 244. The heat is conducted to the motor housing main body 223A through the split core 241 of the stator 221. At this time, since the motor housing main body 223A is made of aluminum, aluminum alloy, magnesium, or magnesium alloy which has a thermal conductivity larger than the motor housing which is generally made of steel and then the motor housing main body is integrally formed with the housing 101 by forging, the heat generated from the motor coil 244 is efficiently conducted to the housing 101 through the motor housing main body 223A, and thus a copper loss which can be allowed by the motor coil 244 can be made larger than that of the known example.

Further, in the above-described embodiment, since the housing 101 and the motor housing main body 223A are formed by casing any one of aluminum, aluminum alloy, magnesium, and magnesium alloy using a die casting machine, there is no limitation in thickness when drawing a thin steel plate in the same manner as the known example. Additionally, since a specific gravity is a third with respect to a thin steel plate, the thickness can be made three times thicker than that of the cylindrical portion of the motor housing made of a thin steel plate according to the known example. Further, the aluminum alloy is a material having thermal conductivity three times larger than that of iron. Furthermore, since the stator front end contacting portion 248 is provided and the heat transfer member 249 is filled in the gap between the coil end and the stator front end contacting portion, heat generated from the coil end due to a copper loss can be conducted to the motor housing main body 223A through the stator front end contacting portion 248 and the heat transfer member 249. In terms of such advantages, the motor housing can be configured to have the same weight as that of the known example, and more heat can be conducted to the housing 101, thereby making the copper loss, which can be allowed by the motor coil 244, remarkably larger than that of the known example.

Since the stator 221 and the magnetic pole portion 257 of the rotor are configured as a slot combination called eight-pole and twelve-slot type, the configuration is four times larger than that of the basic two-pole and three-slot type. In this way, since the configuration of the magnetic pole portion 257 and the stator 221 is 2n times (where, n is a positive number) larger than that of the basic configuration, the magnetic absorbing force in the diameter direction is offset, and thus it is advantageous in that vibration of the rotor in rotation can be made small. In addition, a coil coefficient of the slot combination is ‘0.866’, and it is advantageous in that it is possible to obtain large torque with respect to a steel loss because the coil is concentratedly wound.

However, since a variation amount of the interlinkage magnetic flux due to the respective magnetic poles is directly expressed as cogging torque and torque ripple, it is necessary to reduce the cogging torque and the torque ripple which give an uncomfortable feeling to a driver for the application in the electric power steering apparatus. In this embodiment, the permanent magnet 259 as a magnetic pole corresponds to the segment magnet which is separated for each pole, and the shape is a semi-cylindrical shape in which the circular arc center on the outer circumference is intentionally deviated from the rotation center. In terms of such a magnetic pole, it is possible to change the variation amount of the interlinkage magnetic flux into a sine wave, and it is possible to reduce the torque ripple occurring when applying the sine wave.

In the motor housing cover portion 223B, since the fin-shaped ribs are provided at a position including the resolver 222, it is possible to increase a heat transfer of the ambient circumference of the part in terms of conduction, convection, and radiation compared with the known example. The fixed side of the resolver 222 is hardly influenced by the heat generated by the copper loss of the motor coil 244, and thus it is possible to prevent an abnormal operation, precision reduction, and drift of a signal of the resolver.

Additionally, since the resolver 222 is disposed adjacent to the four-point contact ball bearing 112, it is possible to prevent the resolver stator 222s and the resolver rotor 222r from being deviated in the axial direction by the coefficient of linear expansion of the motor housing material and the shaft material when the motor temperature changes. In particular, when a difference between the coefficients of linear expansion of the motor housing material and the shaft material is large like this embodiment, the advantage is eminent.

Since the positioning operation of the magnetic pole portion 257 and the resolver rotor 222r is mechanically carried out, it is possible to surely prevent symptoms such as a torque reduction and a torque ripple occurring when the phases of the magnetic pole portion and the resolver rotor are deviated from each other, a torque difference caused by a rotation direction, and a self steer which should not occur in the electric power steering apparatus.

Since the permanent magnet 259 constituting the magnetic pole portion 257 is covered by the cap 260, even when the permanent magnet 259 is broken or comes out, or the permanent magnet 259 is peeled off from the rotor yoke 258, the permanent magnet 259 is not drawn to the air gap. Accordingly, it is possible to surely prevent the wheel steering lock caused by a motor lock corresponding to malfunction which should not occur in the electric power steering apparatus.

As described above, according to the embodiment, since the housing 101 is integrally formed with the motor housing main body 223A of the motor housing 223 so as to surround the rotor yoke 258 and the stator yoke 242, heat generated from the motor 109 is conducted through the housing 101 to be thereby emitted to the outside. Accordingly, a heat transfer property is remarkably improved and a cooling effect of the motor 109 increases compared with a case that the housing 101 is formed into a member separated from the motor housing 223. As a result, it is possible to realize an increase in output of the motor 109 as well as a decrease in size and weight. Furthermore, it is possible to realize a decrease in size of the electric power steering apparatus as a whole. In particular, since the material of the housing 101 is aluminum or magnesium, the advantages of a heat emission property and a decrease in weight are more expected.

According to the embodiment, since the bearing 112 for supporting the single rotation shaft 109a in the rear part of the motor 109 is configured as a four-point contact ball bearing, it is possible to receive a force in the axial direction (in both directions) using the bearing without using an additional bearing pre-loading device and the like. Further, with such four-point contact ball bearing, it is possible to reduce rattling movement, and it is possible to allow the tooth surfaces of the worm 108 and the worm wheel 107 to appropriately mesh with each other.

Although a method for removing the rattling movement can be used in which two angular ball bearings are used to support the single rotation shaft 109a, it is necessary to use the pre-loading mechanism and to manage the dimension, whereby the configuration becomes complex. Also, a loss of the bearing becomes large. Thus, it is desirable to facilitate the assembling operation or the dimension management by using the four-point contact ball bearing. Additionally, it is possible to realize a decrease in weight and to reduce a friction loss.

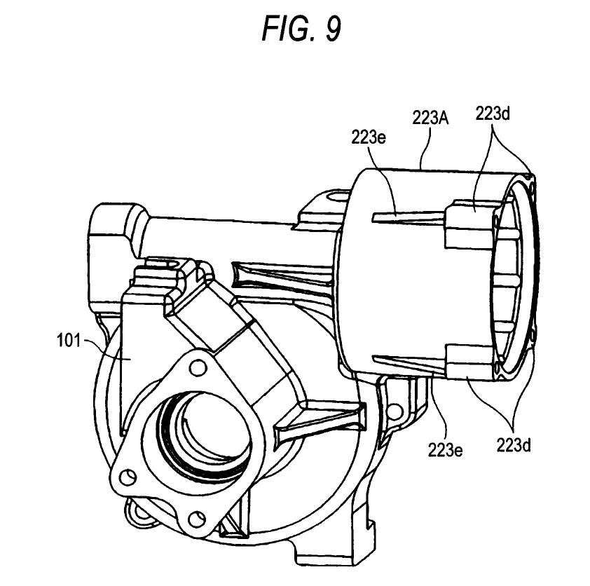

FIG. 9 is a perspective view illustrating the housing according to a modified example. For example, when the pinion housing 101 is integrally formed with the motor housing main body 223A in the same manner as the structure shown in FIG. 3, most of force which is applied from the worm wheel 107 to the worm 108 becomes an axial force to be thereby transmitted to the motor housing cover portion 223B through the rotation shaft 109 and the four-point contact ball bearing 112. Here, since the motor housing cover portion 223B is fixed by a bolt to the motor housing main body 223A, the axial force is transmitted to the motor housing main body through the bolt. However, when the thickness of the motor housing main body 223A is configured to be small in order to realize a decrease in weight or to increase a heat transfer property, a problem arises in the strength.

On the contrary, according to the modified example, since a triangular plate-shaped rib 223e is formed in the vicinity of the motor housing main body 223A so as to be connected to the outer circumferential surface of the motor housing main body 223A and to have a shape in which a screw boss 223d for a fixed bolt extends as shown in FIG. 9. Accordingly, it is possible to increase strength of the motor housing main body 223A. Additionally, since the rib 223e is provided, it is possible to increase a surface area of the motor housing main body 223A and to promote an emission of heat generated from the brushless motor while realizing a decrease in size. At this time, the shape of the rib 223e is not limited to that shown in the drawing.

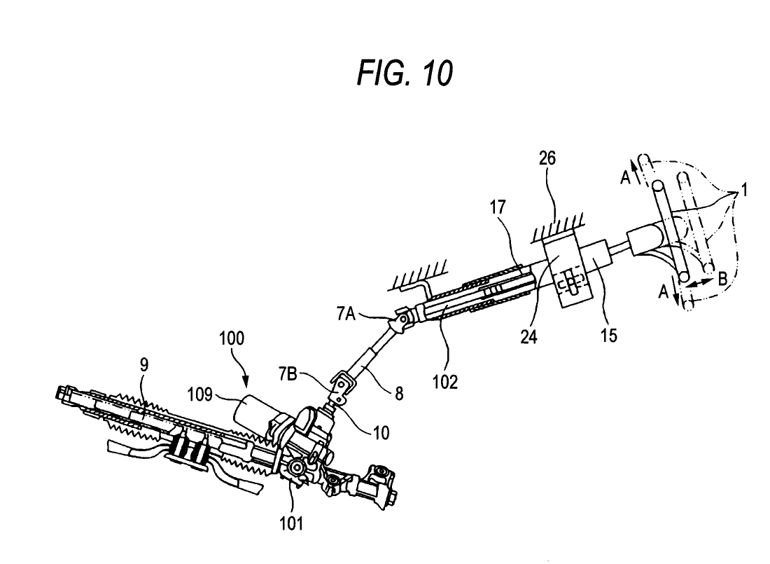

FIG. 10 is a schematic view illustrating a steering mechanism with a pinion-type electric power steering apparatus 100 according to another embodiment. Since the embodiment shown in FIG. 10 is different from the embodiment shown in FIG. 1 in that the electric power steering apparatus 100 shown in FIGS. 2 to 9 is provided in a pinion housing 101, the same reference numerals are given to the same components and the description thereof will be omitted.

Additionally, in FIG. 3, the motor 109 is disposed in a large hole 101c of the housing 101. The motor 109 includes the rotation shaft 109a, a rotor 109b which is disposed around the rotation shaft 109a, and a stator 109d which is provided in the inner circumference of the large hole 101c and is opposed to the rotor 109b. The seal 109e is filled between the large hole 101c and the rotation shaft 109a.

The large hole 101c is mounted to a motor frame 109F which is integrally formed with the housing 101 to be thereby closed by the four-point contact ball bearing supporting holder 111 forming a part of the housing 101. Inside the hollow four-point contact bearing supporting holder 111, the rotation shaft 109a is inserted therethrough and a rotation detector S is provided therein so as to detect a rotation speed of the four-point contact ball bearing 112 and the rotation shaft 109a. One end (left end shown in FIG. 3) of the rotation shaft 109a of the motor 109 is supported to the four-point contact bearing supporting holder 111 through the four-point contact ball bearing 112. A rubber damper GP which is attached to the outer circumference of the rotation shaft 109 is disposed on both sides of the four-point contact ball bearing 112 in the axial direction so as to allow the four-point contact ball bearing 112 to be displaced in the axial direction with respect to the rotation shaft 109 and to apply an urging force in accordance with the displacement amount. On the other hand, the other end (the right end shown in FIG. 3) of the rotation shaft 109a is supported to the housing 101 by a general ball bearing 113 through a worm pre-loading mechanism 120.

On the other hand, when a driver operates the steering wheel 1 in a state that the vehicle turns its direction, the torsion bar 105 twisted in accordance with the force, and then a relative rotating motion occurs between the input shaft 102 and the output shaft 103. The torque sensor 106 outputs a torque signal in accordance with the direction and amount of the relative rotating motion. Since a control circuit (not shown) supplies a driving signal to the motor 109 in accordance with the rotor rotation angle detected by the resolver 222 based on the torque signal and a vehicle speed signal from a sensor (not shown), the motor 109 generates a desired auxiliary steering force. The torque generated by the motor 109 is decelerated by the power transmission mechanisms (108 and 107) and then is transmitted to the output shaft 103. Subsequently, the torque assists the movement of the rack shaft 9 through the intermediate shaft 8. Accordingly, the steering mechanism is operated through the tie-rod 13 to thereby steer a vehicle wheel (not shown).

Additionally, when the housing 101 is integrally formed with the frame 109F of the motor 109, it is possible to remarkably improve a heat transfer property and to efficiently emit heat generated from the motor 109. Accordingly, it is possible to realize a decrease in size and weight of the motor 109. Additionally, when the material of the housing 101 is aluminum or magnesium, it is possible to further improve a heat transfer property and a decrease in weight.

FIG. 10 is a schematic view illustrating the steering mechanism with the pinion-type electric power steering apparatus 100 according to another embodiment. Since the embodiment shown in FIG. 10 is different from the embodiment shown in FIG. 1 in that the electric power steering apparatus 100 shown FIGS. 2 to 10 is provided in the pinion housing 101, the same reference numerals are given to the same components and the description thereof will be omitted.

As described above, while the invention has been described with reference to the embodiment, the invention is not limited to the preferred embodiment, but may be, of course, modified or improved.

The four-point contact bearing supporting holder 111 may be completely integrally formed with the housing 101.

While the invention has been described in detail with reference to the specific embodiment, it should be understood, of course, that various modifications or corrections may be readily made by those skilled in the art without departing from the spirit and the scope of the invention.

This application claims the benefit of Japanese Patent application No. 2005-325958 filed Nov. 10, 2005 and Japanese Patent application No. 2006-276171 filed Oct. 10, 2006, the entire contents of which are incorporated herein by reference.

### INDUSTRIAL APPLICABILITY

As clearly shown in the above description, according to the invention, it is possible to realize a decrease in size and weight while increasing a heat transfer property without reducing an output. Additionally, it is possible to support the rotation shaft of the electric motor without rattling movement while ensuring a decrease in size.

1. An electric power steering apparatus comprising:
a housing;
a motor which is attached to the housing to rotate a rotation shaft;
an output shaft which outputs a steering force for steering a vehicle wheel;
an input shaft which transmits the steering force from the steering wheel to the output shaft; and
a power transmission mechanism which connects the rotation shaft of the motor and the output shaft so that a power is transmitted, wherein
the power transmission mechanism includes a worm which is integrally formed with the rotation shaft and a worm wheel which is connected to the output shaft.

2. The electric power steering apparatus according to claim 1, wherein
an integrally formed housing of the power transmission mechanism forms at least a part of a frame of the motor.

3. The electric power steering apparatus according to claim 2, wherein
the housing of the power transmission mechanism surrounds at least a stator and a rotor of the motor.

4. The electric power steering apparatus according to claim 1, wherein
the motor is a brushless motor.

5. The electric power steering apparatus according to claim 1, wherein
the housing of the power transmission mechanism is made of aluminum, aluminum alloy, magnesium, or magnesium alloy.

6. The electric power steering apparatus according to claim 2, wherein
the housing of the power transmission mechanism is provided with a rib which is disposed in the vicinity of a connection portion of the brushless motor.

7. The electric power steering apparatus according to claim 1, wherein
the rotation shaft is supported to the housing through a four-point contact ball bearing.

8. The electric power steering apparatus according to claim 1, wherein
a worm pre-loading mechanism is provided so as to apply a pre load to tooth surfaces of the worm and the worm wheel meshing with the worm.

9. The electric power steering apparatus according to claim 1, wherein
the rotation shaft is supported to the housing through a bearing at two positions as opposite ends thereof, and
the bearing on the side of the motor is a four-point contact ball bearing.
